(19) United States
(12) Patent Application Publication
(10) Pub. No.: US 2020/0235917 A1
(43) Pub. Date: Jul. 23, 2020

(54) SHARED SECRET GENERATION

(71) Applicant: HEWLETT PACKARD ENTERPRISE DEVELOPMENT LP, Houston, TX (US)

(72) Inventors: Chris Davenport, Houston, TX (US); David Kimler Altobelli, Houston, TX (US)

(21) Appl. No.: 16/254,521

(22) Filed: Jan. 22, 2019

(51) Int. Cl. H04L 9/08; H04L 9/32

(52) U.S. Cl. CPC H04L 9/085; H04L 9/3239; H04L 9/0861

(57) ABSTRACT

Examples disclosed herein relate to generating a shared secret. A processor and a memory. A register in a computing device that is set to a first value. Reading the register when the value of the register has changed to a second value. The register changes to a third value. A shared secret is generated based on the second value.

### BACKGROUND

Service providers and manufacturers are challenged to deliver quality and value to consumers, for example by providing a secure computing system. A data center is a facility used to house computer networks, computer systems, and associated components, such as telecommunications and storage systems. Equipment in a data center may be in the form of servers mounted in rack cabinets.

### BRIEF DESCRIPTION OF THE DRAWINGS

The following detailed description references the drawings, wherein:

FIG. 1 is a block diagram of a computing device capable of generating a shared secret, according to an example;

FIG. 2 is a block diagram of a computing device capable of generating a shared secret, according to an example;

FIG. 3-5 are block diagrams of a computing device capable of generating a shared secret, according to various examples;

FIG. 6 is a flowchart of a method for performing an action using a shared secret, according to an example; and

FIG. 7 is a block diagram of a computing device capable of using a shared secret to perform a security action, according to an example.

Throughout the drawings, identical reference numbers may designate similar, but not necessarily identical, elements. An index number “N” appended to some of the reference numerals may be understood to merely denote plurality and may not necessarily represent the same quantity for each reference numeral having such an index number “N”. Additionally, use herein of a reference numeral without an index number, where such reference numeral is referred to elsewhere with an index number, may be a general reference to the corresponding plural elements, collectively or individually. In another example, an index number of “I,” “M,” etc. can be used in place of index number N.

### DETAILED DESCRIPTION

It can be beneficial to establish shared secrets or trust for previously manufactured devices which do not otherwise include a specific secret value, which can lead to potential security weaknesses in these devices. These weaknesses can be addressed with realization that a physically delivered manufactured device constitutes, in itself, the exchange of some amount of secret information embedded within the physical and behavioral characteristics of the device.

Accordingly, this disclosure pertains to a method and system for interrogating hardware devices, runtime states, and their surrounding environment to establish shared secrets among sets of devices is described. This disclosure provides a way to create shared secrets where no previously known values exist, enabling a wide range of secure functionality which depends on the presence of such secrets. Examples of such functionality include encrypted key exchange, device integrity attestation, automatic trust, etc. Multiple lifetimes and scopes of a secret can be achieved. This approach can also reduce or eliminate the manufacturing cost of implementing unique and shared secrets for large-scale manufacturing of devices.

The hardware device, e.g., a computing device such as a server, can include a processor, memory, a baseboard management controller (BMC), etc. Further, one or more processor or BMC may include one or multiple registers. Moreover, the hardware device may include other settings. In one example, the hardware device can be initialized. As used herein, “initialized” means one or more memory or register values can be set. The setting can be based on a default value or null state upon application of power. The register or memory can be set to a first value and change to a second value at a later time and a third value at another later time. In some of these examples, the value can be changed from the first value to the third value quickly (e.g., as part of a boot or initialization process). The second value can be used to generate a shared secret. Because the value of the register or memory location is changed, it can be more difficult to replicate by a malicious actor.

Further, multiple such values can be used in a derivation function to create a shared secret. The derivation can be a one way hash function. Further, the derivation function can be a slow one way has function. As used herein, a “derivation function” is used to derive one or more secret keys from a secret value, a password, or a passphrase using a pseudorandom function. Examples of derivation functions include keyed cryptographic hash functions. As used herein, a one-way hash function is a hash function used to compute a variable-length input string into a value (e.g., a binary sequence) that is designed in such a way that it is hard to reverse the process. Further, the hash function used can be a slow hash function. A benefit of having a slow hash function is that it makes brute-force attacks less feasible. Thus, the hash calculation can be slow (e.g., by using many internal iterations or by making the calculation memory intensive). Examples of hash functions include MD4, MD5, SHA, SHA256, etc. The whole or a portion of the second value as well as other values can be used to generate the shared secret.

In one example, the hardware device is a server and each server using the same firmware stack and configuration can be assumed to have the same second value. In this case, a manufacturer can create a shared secret using this approach. Further, the manufacturer can separately make each unique by also including a unique value for each hardware device (e.g., a serial number or other string known by the manufacturer to be unique to the hardware device). The shared secrets can be used a variety of ways. In one example, the shared secret can be used to authenticate or decrypt a firmware update. In one example, the shared secret can be used as a key. In another example, the shared secret can be used to wrap cryptographic key. As noted, some shared secrets can be between a manufacturer and the devices. Other shared secrets can be between two hardware devices of the same type and software stack.

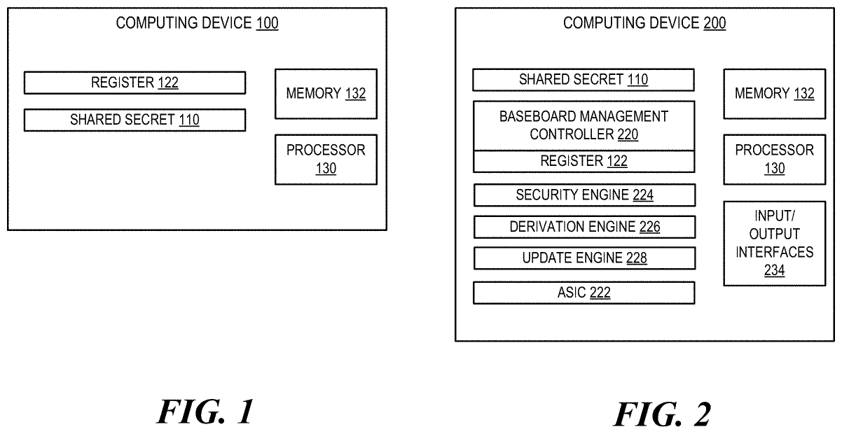

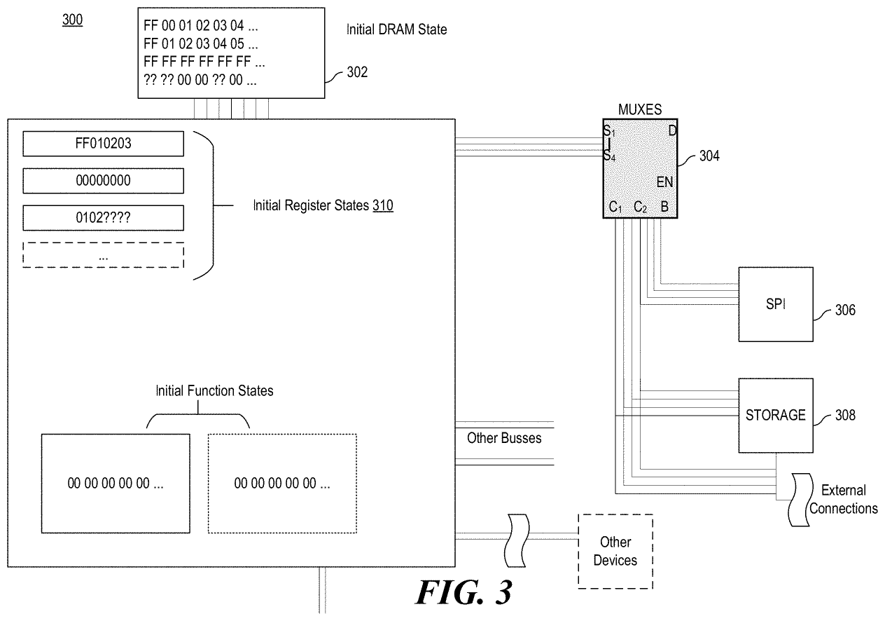

FIG. 1 is a block diagram of a computing device capable of generating a shared secret, according to an example. FIG. 2 is a block diagram of a computing device capable of generating a shared secret, according to an example. Computing devices 100, 200 include components that can be utilized to generate and use a shared secret. The respective computing devices 200, 200 may be a notebook computer, a desktop computer, a tablet computing device, a wireless device, a server, a workstation, an enclosure for a set of blade servers or cartridges, or any other computing device that is capable of providing the functionality described within.

As noted previously, a computing device 100, 200 such as a server, can include a processor 130, memory 132, a baseboard management controller (BMC) 220, etc. Further, one or more processor 130 or BMC 220 may include one or multiple registers 122. As used herein a “register” is a part of a processor 130 or BMC 220 that can hold an instruction, a storage address, or other data. Generally registers are part of a small amount of fast storage included in the processor.

Moreover, the computing device 100, 200 may include other settings. In one example, the computing device 100, 200 can be initialized. During initialization, registers, memory, etc. can be set based on a default value or null state upon application of power. The register 122 or memory 132 can be set to a first value and change to a second value at a later time and a third value at another later time. In some of these examples, the value can be changed from the first value to the third value quickly (e.g., as part of a boot or initialization process). The second value can be used to generate a shared secret. Because the value of the register 122 or memory location is changed, it can be more difficult to replicate by a malicious actor. Further, specific locations, such as a register can be difficult for a malicious actor to obtain access to.

Further, multiple such values can be used in by a derivation engine 226 in a derivation function to create a shared secret 110. The derivation engine 226 can use a one way hash function. Further, the derivation function can be a slow one way has function. As used herein, a “derivation function” is used to derive one or more secret keys from a secret value, a password, or a passphrase using a pseudorandom function. Examples of derivation functions include keyed cryptographic hash functions. As used herein, a one-way hash function is a hash function used to compute a variable-length input string into a value (e.g., a binary sequence) that is designed in such a way that it is hard to reverse the process. Further, the hash function used can be a slow hash function. A benefit of having a slow hash function is that it makes brute-force attacks less feasible. Thus, the hash calculation can be slow (e.g., by using many internal iterations or by making the calculation memory intensive). Examples of hash functions include MD4, MD5, SHA, SHA256, etc. The whole or a portion of the second value as well as other values can be used to generate the shared secret 110.

In one example, the information from the second value of the register can be used in conjunction with a memory location. In this example, the memory can be set to a first value at a first time, changed to a second value at a second time, and then again changed to a third value at a third later time.

As used herein, a second value that has been changed from a first value at a first time and later changed at a third later time to a third value can be considered a “middle value.” A middle value can be used for sampling registers, memory, and other information. In some examples, a manufacturer of a computing device 100, 200 may have access to information contained within these registers, memory, etc. due to testing of the computing device 100, 200 while the computing device 100, 200 is in a factory mode where once the computing device 100, 200 is changed to a production mode and sent outside of the factory.

In some examples, when a computing device such as a server is assembled and begins the factory process, it can be in a factory security state. This factory security state allows access to information and programming of data on the computing device in order to prepare it to ship to a customer. This can allow for security parameters such as management passwords to be written and read. In some examples, the factory security state can be used for, license confirmation, factory initialization of components within a device chassis, testing devices using direct access, verifying and recording inventory of devices and/or settings in the device, etc. Once the computing device has completed the factory process, the computing device is put into a production security state. This can lock and prevent access to password and other information on the computing device by limiting capabilities to access these features. This can be the desired security state to harden the computing device for field use. Thus, the device is more secure in the production security state.

In one example, the information can be read by a BMC 220 (or other application specific integrated circuit (ASIC) 222) and during the factory security state, the BMC 220 can be programmed to read these values and provide them. In another example, while the BMC 220 (or other ASIC 222) is in the production security state, the BMC 220 does not provide access to the information. Platform firmware, the BMC 220, and various other ASICs 222 such as field programmable gate arrays (FPGAs), complex programmable logic devices (CPLDs), controllers, etc. can be programmed such that a manufacturer may have access to one or more of the middle values, but an in production system will not provide them.

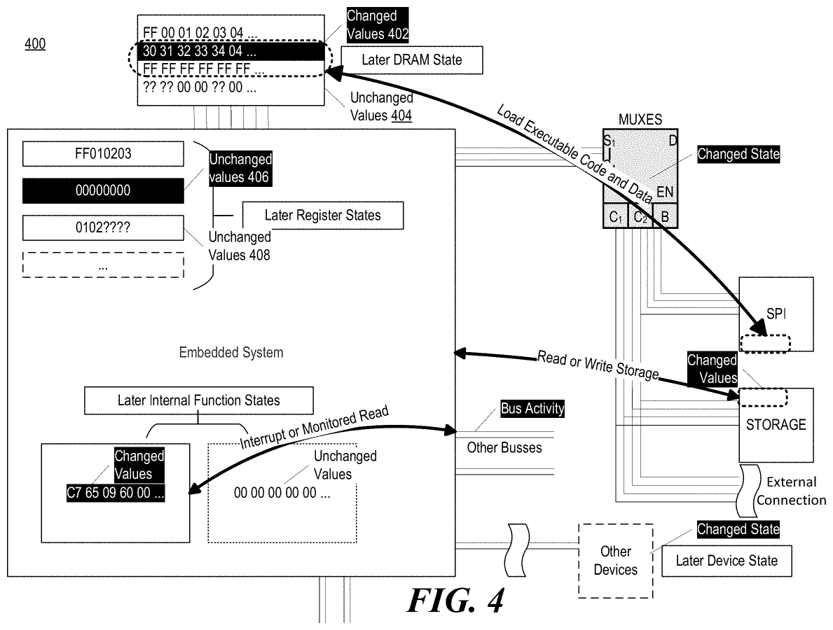

In one example, the register 122 is part of the BMC 220 and thus the BMC 220 can read the value of the register 122. In another example, the register 122 is part of another controller that is accessible to the BMC 220 (e.g., via a bus) and the BMC 220 can read that value and provide it. Examples of such controllers include SPI devices, storage controllers, and the like. Moreover, one or more parts of the values can be programmed to be masked and/or combined to generate the value as further discussed in the examples of FIGS. 3, 4, and 5.

As noted, the derivation engine 226 can create the shared secret 110 using a derivation function (e.g., a one way hash function). The derivation function can be a slow derivation function as described above. In some examples, the derivation engine 226 can be implemented as part of the BMC 220. In other examples, the derivation engine 226 can be implemented as part of another processor, for example, a central processing unit implementing platform firmware.

In some examples, the shared secret 110 can be determined by the BMC 220 once the computing device 200 is plugged in, before it is even started. In this example, BMC 220 can be programmed to retrieve one or more middle values and use them as part of the derivation function. In one example, each of computing devices 100, 200 with a same model, type, and the same firmware version and configuration can have the same shared secret 110. In another example, the shared secret 110 can also be based on device specific information, for example, a serial number, identified hardware information that is specific to each computing device 100, 200 and saved by the manufacturer, etc. Thus, the shared secret 110 can be different for each computing device 100, 200. In some examples, the computing device 100, 200 can be configured such that the shared secret 110 is generated each time the device is plugged in, reset, etc. In other examples, the shared secret 110 can be created and stored in a secure storage (e.g., via a Trusted Platform Module, a trusted area of the BMC 220, etc.) of the computing device 100, 200. With the approaches used here, the hardware/firmware of the computing device 100, 200 can be used to create a shared secret that is predictable to a manufacturer of the device and also secure.

A security engine 224 can use the shared secret 110 to perform a security action. In one example, the security action can include authenticating a value, for example, authenticating a firmware package, a communication, etc. In another example, the security action can include using the shared secret 110 for decrypting a communication, a binary, a file, a firmware package etc. In other examples, the shared secret may be used to encrypt or decrypt information, devices (e.g., storage drives), etc. In one example, the shared secret can be used to wrap a password, token, etc. to unlock a private key. The private key can be used to authenticate and/or decrypt information. This can be considered one use of the shared secret to authenticate or decrypt something, for example, a firmware image, a firmware update, etc. In other examples, the shared secret can be used as a key.

The update engine 228 can be implemented to update firmware. In one example, the BMC 220 can receive a firmware package that is signed or encrypted. The shared secret 110 can be used to either authenticate or decrypt the firmware package. The update engine 228 can then perform the update. The update can be to the BMC 220, platform firmware, an ASIC 222, or other device of the computing device 100, 200. In some examples, firmware packages can initially be sent in clear text until a shared secret 110 is created. At that time, a shared secret 110 can be implemented and used for a next firmware package to be installed. That firmware package can change the derivation function used such that a different shared secret is created. This way, a malicious actor cannot attempt to derive the shared secret from the clear text of a firmware package.

The engines 224, 226, 228 include hardware and/or combinations of hardware and programming to perform functions provided herein. Moreover, the modules (not shown) can include programing functions and/or combinations of programming functions to be executed by hardware as provided herein. When discussing the engines and modules, it is noted that functionality attributed to an engine can also be attributed to the corresponding module and vice versa. Moreover, functionality attributed to a particular module and/or engine may also be implemented using another module and/or engine.

A processor 130, such as a central processing unit (CPU) or a microprocessor suitable for retrieval and execution of instructions and/or electronic circuits can be configured to perform the functionality of any of the engines 224, 226, 228 described herein. Multiple processors can be used in a computing device 100, 200 (e.g., a CPU, a BMC 220, hardware microcontrollers, I/O controllers, etc.). In certain scenarios, instructions and/or other information can be included in memory 132 or other memory. Input/output interfaces 234 may additionally be provided by the computing device 200. For example, input devices, such as a keyboard, a sensor, a touch interface, a mouse, a microphone, etc. can be utilized to receive input from an environment surrounding the computing device 200. Further, an output device, such as a display, can be utilized to present information to users. Examples of output devices include speakers, display devices, amplifiers, etc. Moreover, in certain examples, some components can be utilized to implement functionality of other components described herein. Input/output devices such as communication devices like network communication devices or wireless devices can also be considered devices capable of using the input/output interfaces 234.

In some examples, the BMC 220 can be used to implement services for the computing device 200. BMC 220 can be implemented using a separate processor from the processing element or processor 130 that is used to execute a high level operating system (e.g., a host processor). BMCs can provide so-called “lights-out” functionality for computing devices. The lights out functionality may allow a user, such as a systems administrator, to perform management operations on the computing device 200 even if an operating system is not installed or not functional on the computing device.

Moreover, in one example, the BMC 220 can run on auxiliary power, thus the computing device 200 need not be powered on to an on state where control of the computing device 200 is handed over to an operating system after boot. As examples, the BMC 220 may provide so-called “out-of-band” services, such as remote console access, remote reboot and power management functionality, monitoring health of the system, access to system logs, and the like. As used herein, a BMC 220 has management capabilities for sub-systems of a computing device 200, and is separate from a processing element or processor 130 that executes a main operating system of a computing device (e.g., a server or set of servers).

As noted, in some instances, the BMC 220 may enable lights-out management of the computing device 200, which provides remote management access (e.g., system console access) regardless of whether the computing device 200 is powered on, whether a primary network subsystem hardware is functioning, or whether an OS is operating or even installed. The BMC 220 may comprise an interface, such as a network interface, and/or serial interface that an administrator can use to remotely communicate with the BMC 220. As used herein, an “out-of-band” service is a service provided by the BMC 220 via a dedicated management channel (e.g., the network interface or serial interface) and is available whether the computing device 200 is in powered on state.

In some examples, a BMC 220 may be included as part of an enclosure. In other examples, a BMC 220 may be included in one or more of the servers (e.g., as part of the management subsystem of the server) or connected via an interface (e.g., a peripheral interface). In some examples, sensors associated with the BMC 220 can measure internal physical variables such as humidity, temperature, power supply voltage, communications parameters, fan speeds, operating system functions, or the like. The BMC 220 may also be capable to reboot or power cycle the device. As noted, the BMC 220 allows for remote management of the device, as such, notifications can be made to a centralized station using the BMC 220 and passwords or other user entry can be implemented via the BMC 220.

A firmware engine (not shown) can be implemented using instructions executable by a processor and/or logic. In some examples, the firmware engine can be implemented as platform firmware. Platform firmware may include an interface such as a basic input/output system (BIOS) or unified extensible firmware interface (UEFI) to allow it to be interfaced with. The platform firmware can be located at an address space where a processing element (e.g., CPU) for the computing device 100, 200 boots. In some examples, the platform firmware may be responsible for a power on self-test for the computing device 100, 200. In other examples, the platform firmware can be responsible for the boot process and what, if any, operating system to load onto the computing device 100, 200. Further, the platform firmware may be capable to initialize various components of the computing device 100, 200 such as peripherals, memory devices 132, memory controller settings, storage controller settings, bus speeds, video card information, etc. In some examples, platform firmware can also be capable to perform various low level functionality while the computing device 100, 200 executes. Moreover, in some examples, platform firmware may be capable to communicate with a higher level operating system executing on a CPU, for example via an advanced configuration and power interface (ACPI).

In some examples, the platform firmware can be used to derive a shared secret 110 using the approaches described herein. Further, multiple devices can communicate via one or more busses to provide information used to create the shared secret 110.

FIG. 3-5 are block diagrams of a computing device capable of generating a shared secret, according to various examples. A hardware device with optional internal registers, attached ram, storage, and busses of varying types such as a typical embedded system 300, 400, 500 is shown. The system 300 can include multiple devices such as a dynamic random-access memory (DRAM) 302, Multiplexors 304, an SPI device 306, storage 308, registers 310, etc. It can also be connected to other devices via busses.

System 300 initializes to some partially known first state, as may occur following a reset, power-on event, or other event. Some well-known aspects of the state can highly predictable, for example, the contents of a flash part with executable code, or initial values of hardware registers such as counters.

As noted above, a manufacturer may have more information about these components than others. Some partially-known aspects of the state are predictable within limits, for example, the high bits or year portion of a clock, or may rely on undocumented behavior of the device, such as the initial value of an uninitialized register, area of memory, or attached hardware. Some unknown aspects of the state are stable and consistent within limits, such as the significant value of a high-resolution timer after a fixed amount of time has passed, or the value observed on a temperature sensor. These values may vary by environment and depend on manufacturing variances, like an external clock skew, and on external factors like datacenter thermal characteristics. Other unpredictable aspects of the state are nearly random. For example, low bits of a high-resolution timer, external interrupt counters, contents of volatile RAM, for example can be unpredictable on a consistent basis.

As the device performs its designed functions, such as execution of code or response to input signals, some aspects of state change, and previous values may be lost. System 400 shows example state changes, for example a first DRAM state 402 may be changed wile a second DRAM state 404 may not be changed. Moreover, register values may be unchanged 406, 408 at this time. As shown, states can change as well, for example, in devices and busses.

These additional states may be sampled again, providing another partially known second state in system 500. In this example, an unchanged register from 406 changes in value in 506. Further a changed register 507 can change again, however, the top 4 bits in the register 507 can remain consistent or expected. Other examples from FIGS. 4 and 5 include values from DRAM, EEPROM, SPI devices, storage, other devices, etc.

As noted, a secret is then derived through the combination of these aspects of the system. Aspects which are not dependent on executable code content or contents of flash parts can be considered secret from attackers which can access or reverse engineer those parts. Aspects which depend on manufacturing or environmental variances can be considered secret from attackers which do not have physical access to the device in its regular installation environment. Aspects which depend on behavior of the system may be considered secret from attackers which do not have access to the device, its documentation, or the ability to run code on the device. These aspects can then be selected to form secrets which are broadly common to a large set of devices, or narrowly specific to a single device in a specific installation environment, and varyingly resistant to attack.

In an example derivation of a secret from system 500, several aspects are fed into a secure hash algorithm, including the value of an internal clock register, masked to the current year 502, the measured first state of the running code which performed the interrogation 504, the processor instruction count 506, and the common values within an external EEPROM 508. The resulting hash output provides an initial secret which is unique to all devices with the same firmware and EEPROM values, for a specific year. Other clock settings, running state of code, instruction counts, common values, etc. can be used in generating shared secrets.

In one example, an initial secret can be provided to a high-iteration count of a slow Key derivation function, to add guess resistance against the partial predictability of some values, like the instruction count, to produce a final secret or shared secret. The shared secret can be unknown to outside attackers which possess similar hardware and access to firmware images, but cannot interrogate register values without disrupting instruction counters, changing running code first state measurements, or altering internal clock values.

Physical tamper evidence and detection techniques may be used to confirm the secrecy of device unique values after their initial generation. The secrets may be broadly shared among an entire class of device, or specialized to a particular installation or environment. The approaches described herein can be further specialized to produce unique device secrets, with lifetimes that range from permanent for the life of the device or ephemeral for a single instance.

In one example, a device with a built-in or attached positioning system or other location sensor may be able to use location data to prove its proximity to other devices of interest, such as identical devices within the same datacenter, or management relationships. In another example, a data classifier may be trained for different states, and register variations from known behavior and configurations. The data classifier could be implemented within the embedded system, or as a logically independent unit of the chip, chip complex, or board.

The system may be connected to other devices via a communication network, which may use wired communications, wireless communications, or combinations thereof. Further, the communication network can include multiple sub communication networks such as data networks, wireless networks, telephony networks, etc. Such networks can include, for example, a public data network such as the Internet, local area networks (LANs), wide area networks (WANs), metropolitan area networks (MANs), cable networks, fiber optic networks, combinations thereof, or the like. In certain examples, wireless networks may include cellular networks, satellite communications, wireless LANs, etc. Further, the communication network can be in the form of a direct network link between devices. Various communications structures and infrastructure can be utilized to implement the communication network(s).

By way of example, the devices can communicate with each other and other components with access to the communication network via a communication protocol or multiple protocols. A protocol can be a set of rules that defines how nodes of the communication network interact with other nodes. Further, communications between network nodes can be implemented by exchanging discrete packets of data or sending messages. Packets can include header information associated with a protocol (e.g., information on the location of the network node(s) to contact) as well as payload information.

In one example, the embedded system can be implemented as a BMC that is included as part of a larger system or device. In some examples, a BMC may be connected via a communication port. Further, in some examples, the communication port may be part of a public or private network. In one example, a server may be associated with a production network (e.g., connected to the Internet or an Ethernet) and may be separated from a management network that is connected to one or multiple BMCs and/or a management station.

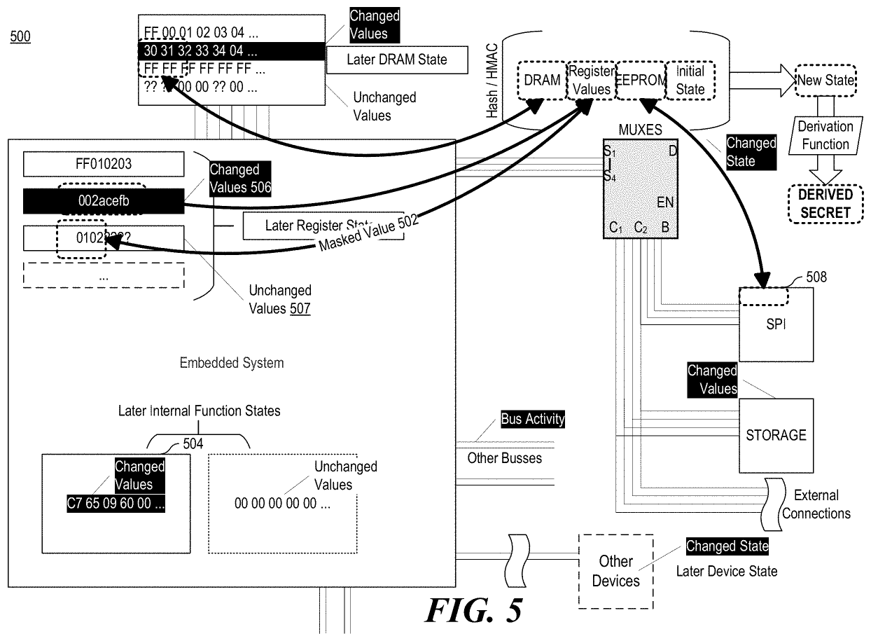

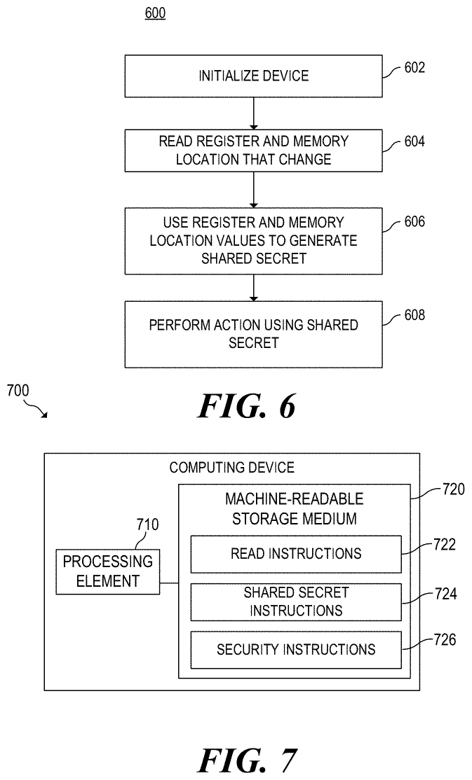

FIG. 6 is a flowchart of a method for performing an action using a shared secret, according to an example. FIG. 7 is a block diagram of a computing device capable of using a shared secret to perform a security action, according to an example. The computing device 700 includes, for example, a processing element 710, and a machine-readable storage medium 720 including instructions 722, 724, 726 for generating and using a shared secret. Computing device 700 may be, for example, a notebook computer, a slate computing device, a portable reading device, a wireless email device, a mobile phone, a server, an enclosure for a server or set of blade servers, an enclosure for a switch, or any other computing device.

Processing element 710 may be, one or multiple central processing unit (CPU), one or multiple semiconductor-based microprocessor, one or multiple graphics processing unit (GPU), other hardware devices suitable for retrieval and execution of instructions stored in machine-readable storage medium 720, or combinations thereof. The processing element 710 can be a physical device. Moreover, in one example, the processing element 710 may include multiple cores on a chip, include multiple cores across multiple chips, multiple cores across multiple devices (e.g., if the computing device 700 includes multiple node devices), or combinations thereof. Processing element 710 may fetch, decode, and execute instructions 722, 724, 726 to implement method 600. As an alternative or in addition to retrieving and executing instructions, processing element 710 may include at least one integrated circuit (IC), other control logic, other electronic circuits, or combinations thereof that include a number of electronic components for performing the functionality of instructions 722, 724, 726.

Machine-readable storage medium 720 may be any electronic, magnetic, optical, or other physical storage device that contains or stores executable instructions. Thus, machine-readable storage medium may be, for example, Random Access Memory (RAM), an Electrically Erasable Programmable Read-Only Memory (EEPROM), a storage drive, a Compact Disc Read Only Memory (CD-ROM), and the like. As such, the machine-readable storage medium can be non-transitory. As described in detail herein, machine-readable storage medium 720 may be encoded with a series of executable instructions for generating a shared secret and using the shared secret.

Although execution of method 600 is described below with reference to computing device 700, other suitable components for execution of method 600 can be utilized (e.g., computing device 100, 200). In some examples, the processing element 710 can be implemented using a BMC. Additionally, the components for executing the method 600 may be spread among multiple devices. Method 600 may be implemented in the form of executable instructions stored on a machine-readable storage medium, such as storage medium 720, and/or in the form of electronic circuitry.

At 602, the computing device 700 can be initialized. In one example, the initialization can be in response to a reset vector. In another example, the initialization can be based on a power on or other event. As noted, one or more registers, states, memory locations, etc. can be set to a value at the time of initialization. In some examples, each respective microcontroller in a device can perform its separate initialization vectors when the reset vector or power event is performed.

Processing element 710 can execute read instructions 722 to read one or more registers, memory locations, states, etc. as detailed throughout the Specification (604). As noted previously, a register of the computing device 700 can be set to a first value. The register can be changed to a second value at another time. The second value can later be changed to a third value. Further, as noted, a similar action can be performed for a memory location. As such, the computing device 700 can read a memory location that is set to a fourth value and is changed to a fifth value at a later time. The processing element 710 can read the second value from the register and the fourth value at the memory location. The reading can be direct (e.g., direct access to the register or memory location via direct memory access) or indirect (e.g., requesting another device to read the location and report a value). As noted above, the processing element 710 can be implemented as a BMC. Further, the register can be part of the processing element or BMC or be accessible by the processing element or BMC.

At 606, the processing element 710 can execute shared secret instructions 724 to generate a shared secret based on the second value and the fourth value. As noted above, additional values can be used (e.g., as in the examples of FIGS. 3-5). As noted, the shared secret may be the same for a set of a same class of computing system (e.g., a set of computing systems with a same predictable set of chosen values). In another example, the approach may be similar, but the shared secret can be unique for each computing system (e.g., using a unique value such as a serial number or known tested hardware value). A manufacturer may keep track of certain unique information about each system for this approach.

At 608, security instructions 726 can be executed by the processing element 710 to perform a security action using the shared secret. As noted above, the shared secret can be used to authenticate and/or decrypt one or more files or communications such as firmware or firmware image (e.g., a firmware update package). This can be direct or indirect (e.g., via wrapping and/or unwrapping of a private key, password, or token). As used herein, a firmware image is a binary that can be used to update one or more firmware of a computing system.

While certain implementations have been shown and described above, various changes in form and details may be made. For example, some features that have been described in relation to one implementation and/or process can be related to other implementations. In other words, processes, features, components, and/or properties described in relation to one implementation can be useful in other implementations. Furthermore, it should be appreciated that the systems and methods described herein can include various combinations and/or sub-combinations of the components and/or features of the different implementations described. Thus, features described with reference to one or more implementations can be combined with other implementations described herein.

What is claimed is:

1. A computing device comprising:
at least one processor;
memory;
a plurality of registers,
wherein the at least one processor is to:
initialize the computing device,
wherein the registers are set to a first value and at least one register is changed to a second value at a first later time,
wherein, at a second later time, the at least one register is changed to a third value,
wherein the at least one processor is further to generate a shared secret based on the second value.

2. The computing device of claim 1, wherein the memory includes a location that is set to a fourth value, changed to a fifth value at a third later time, and wherein the shared secret is further based on the fourth value.

3. The computing device of claim 1, wherein the at least one register is included in a baseboard management controller.

4. The computing device of claim 1, wherein the at least one register is included in a controller accessible to a baseboard management controller.

5. The computing device of claim 1, wherein the shared secret is the same for a plurality of computing systems.

6. The computing device of claim 1, wherein the shared secret is used to authenticate or decrypt a firmware update.

7. The computing device of claim 1, wherein a derivation function is used to create the shared secret.

8. The computing device of claim 7, wherein the derivation function is a one way hash function.

9. The computing device of claim 1, wherein the shared secret is used to subsequently decrypt and validate a firmware image.

10. The computing device of claim 1, wherein the shared secret is the unique for each of a plurality of computing systems.

11. A non-transitory machine-readable storage medium storing instructions that, if executed by a physical processing element of a device, cause the device to:
initialize the device, wherein a first register is set to a first value;
read the first register at a time after the first value is changed to a second value, wherein at a second later time, the first register is changed to a third value; and
generate a shared secret using a slow derivation function based on the second value.

12. The non-transitory machine-readable storage medium of claim 11, wherein the device further includes a memory and the memory includes a location that is set to a fourth value and changed to a fifth value at a third later time and wherein the shared secret is based on the fourth value.

13. The non-transitory machine-readable storage medium of claim 11, wherein the first register is included in or accessible by a baseboard management controller.

14. The non-transitory machine-readable storage medium of claim 11, wherein the shared secret is unique for a plurality of computing systems.

15. The non-transitory machine-readable storage medium of claim 11, wherein a derivation function is used to create the shared secret, wherein the slow derivation function is a one way hash function.

16. The non-transitory machine-readable storage medium of claim 15, wherein the shared secret is used to subsequently decrypt and validate a firmware image.

17. A method comprising:
initializing a device,
wherein a first register of the device is set to a first value;
reading the first register at a time after the first value is changed to a second value, wherein a value of the first register subsequently changes to a third value,
wherein the device further includes a memory and the memory includes a location that is set to a fourth value and changed to a fifth value at a later time;
reading the fourth value; and
generating a shared secret based on the second value and the fourth value using a slow derivation function including a one way hash function.

18. The method of claim 17, wherein the first register is included in a baseboard management controller.

19. The method of claim 17, wherein the shared secret is the unique for a plurality of computing systems.

20. The method of claim 17, wherein the shared secret is used to authenticate a firmware.
